(19) United States
(12) Patent Application Publication
(10) Pub. No.: US 2026/0238069 A1
(43) Pub. Date: Aug. 13, 2026

(54) ROTARY MACHINE SYSTEM AND NEGATIVE PRESSURE UNIT

(71) Applicant: MITSUBISHI HEAVY INDUSTRIES COMPRESSOR CORPORATION, Hiroshima-shi (JP)

(72) Inventors: Eijo Fujiwara, Hiroshima-shi (JP); Michio Kubota, Hiroshima-shi (JP)

(73) Assignee: MITSUBISHI HEAVY INDUSTRIES COMPRESSOR CORPORATION, Hiroshima-shi (JP)

(21) Appl. No.: 19/151,807

(22) PCT Filed: Jan. 23, 2024
(86) PCT No.: PCT/JP2024/001847

§ 371 Date: Jul. 29, 2025

(30) Foreign Application Priority Data
Jan. 31, 2023 (JP) 2023-012461

(51) Int. Cl. H02K 5/167; F16C 33/66; H02K 11/25

(52) U.S. Cl. CPC H02K 5/1672; F16C 33/667; F16C 33/6685; H02K 11/25; F16C 2233/00; F16C 2380/26; H02K 2205/09

(57) ABSTRACT

A rotary machine system includes: a rotary machine including a rotor having a rotor shaft rotatable about an axis, a casing covering the rotor from an outer side in a radial direction centered on the axis, and a shaft bearing device rotatably supporting the rotor shaft with respect to the casing; a drain line that recovers lubricating oil supplied to the shaft bearing device; an oil tank that stores the lubricating oil recovered through the drain line; and a negative pressure unit that is disposed partway along the drain line and reduces pressure inside the shaft bearing device.

### TECHNICAL FIELD

The present disclosure relates to a rotary machine system and a negative pressure unit.

The present application claims priority on JP 2023-012461, filed Jan. 31, 2023, the content of which is incorporated herein by reference.

### BACKGROUND ART

Lubricating oil is supplied to a shaft bearing device configured to rotatably support a rotor shaft in a rotary machine. In such a shaft bearing device, the supplied lubricating oil may leak in some cases. In particular, when the rotary machine is an electric motor, the lubricating oil is likely to leak when the pressure in the shaft bearing device rises. Accordingly, the pressure in a bearing housing may be made to take a negative pressure by sucking gas in the shaft bearing device with a suction device or the like.

For example, Patent Document 1 discloses a shaft bearing device including a bearing that is sealed and disposed in a housing by a contact seal, a lubricating oil supply scheme that supplies lubricating oil together with compressed air to the bearing, and an air suction scheme that sucks air from the housing. In such a configuration, the amount of air sucked from the space in the housing is made to be larger than the amount of air sucked from the clearance of the bearing by the ejector (air suction scheme). With this, the pressure in the space inside the housing is always kept negative relative to the outside, whereby a situation in which the lubricating oil leaks out of the housing is suppressed.

### CITATION LIST

### Patent Literature

Patent Document 1: JP 2006-77851 A

### SUMMARY OF INVENTION

### Technical Problem

However, with the configuration described in Patent Document 1, a reduction in pressure brought by the ejector is applied not only to the shaft bearing device as a pressure reduction target, but also to other portions through, for example, a pipe connected with the ejector, which may bring about an adverse effect. As a result, a design change may be required.

The present disclosure provides a rotary machine system and a negative pressure unit capable of suppressing a situation in which a pressure reduction brought by an ejector spreads to portions other than a shaft bearing device as a pressure reduction target while suppressing the leakage of lubricating oil from the shaft bearing device.

### Solution to Problem

A rotary machine system according to the present disclosure includes: a rotary machine including a rotor having a rotor shaft rotatable about an axis, a casing covering the rotor from an outer side in a radial direction centered on the axis, and a shaft bearing device rotatably supporting the rotor shaft with respect to the casing; a drain line that recovers lubricating oil supplied to the shaft bearing device; an oil tank that stores the lubricating oil recovered through the drain line; and a negative pressure unit that is disposed partway along the drain line and reduces pressure inside the shaft bearing device. The negative pressure unit includes an oil inlet connected to the drain line and communicating with the shaft bearing device, an oil outlet connected to the drain line and communicating with the oil tank, an oil flow pipe that connects the oil inlet and the oil outlet and forms a flow path for the lubricating oil, and an ejector that includes a suction port connected to the oil flow pipe and extracts gas in the oil flow pipe through the suction port to reduce pressure in the oil flow pipe. The oil flow pipe includes an oil retention pipe that is located on a downstream side of the suction port in a flow direction of the lubricating oil and is capable of storing the lubricating oil below the oil inlet and the oil outlet in a vertical direction.

A negative pressure unit according to the present disclosure is a negative pressure unit that is disposed partway along a drain line configured to feed, to an oil tank, lubricating oil supplied to a shaft bearing device of a rotary machine, the negative pressure unit including: an oil inlet connectable to the drain line and communicating with the shaft bearing device; an oil outlet connectable to the drain line and communicating with the oil tank; an oil flow pipe that connects the oil inlet and the oil outlet and forms a flow path for the lubricating oil; and an ejector that includes a suction port connected to the oil flow pipe and extracts gas in the oil flow pipe through the suction port to reduce pressure in the oil flow pipe. The oil flow pipe includes an oil retention pipe that is located on a downstream side of the suction port in a flow direction of the lubricating oil and is capable of storing the lubricating oil below the oil inlet and the oil outlet in a vertical direction.

### Advantageous Effects of Invention

According to the rotary machine system and the negative pressure unit of the present disclosure, a situation in which a pressure reduction brought by an ejector spreads to portions other than a shaft bearing device as a pressure reduction target may be suppressed while suppressing the leakage of lubricating oil from the shaft bearing device.

### BRIEF DESCRIPTION OF DRAWINGS

FIG. 1 is a diagram illustrating a schematic configuration of a rotary machine system according to the present embodiments.

FIG. 2 is a cross-sectional view illustrating a configuration of a negative pressure unit of a rotary machine system according to a first embodiment.

FIG. 3 is a cross-sectional view illustrating a configuration of a negative pressure unit of a rotary machine system according to a second embodiment.

FIG. 4 is a cross-sectional view illustrating a configuration of a negative pressure unit of a rotary machine system according to a modification example of the present embodiments.

FIG. 5 is a diagram illustrating a schematic configuration of a rotary machine system according to a modification example of the present embodiments.

### DESCRIPTION OF EMBODIMENTS

Hereinafter, embodiments for implementing a rotary machine system and a negative pressure unit according to the present disclosure will be described with reference to the accompanying drawings. However, the present disclosure is not limited only to these embodiments.

### Configuration of Rotary Machine System

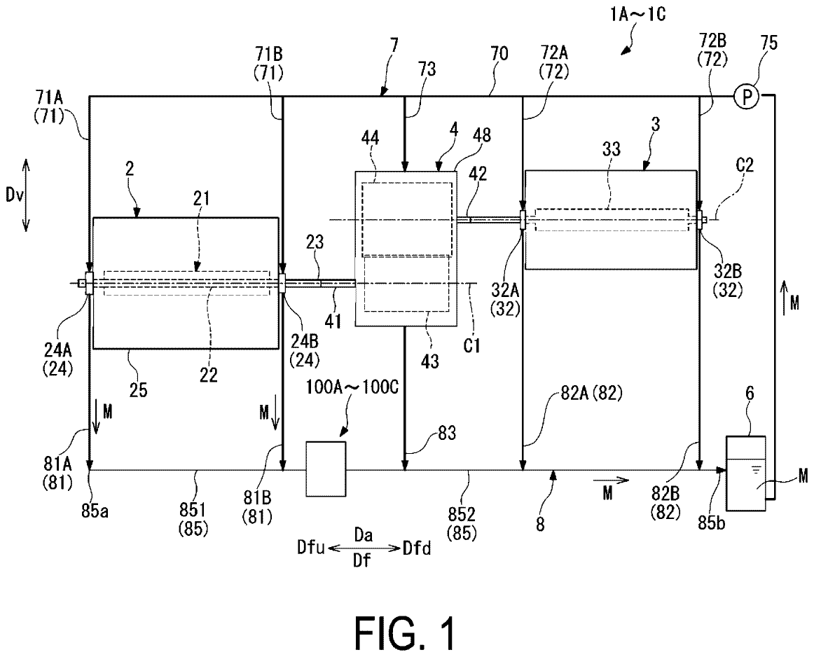

As illustrated in FIG. 1, a rotary machine system 1A mainly includes an electric motor (rotary machine) 2, a compressor 3, a transmission 4, an oil tank 6, a lubricating oil supply line 7, a drain line 8, and a negative pressure unit 100A. The rotary machine system 1A of the present embodiment includes one compressor 3 and one transmission 4, but the present disclosure is not limited to such a form. The rotary machine system 1A may include a plurality of the compressors 3 and a plurality of the transmissions 4. Further, the structure of the system may be such that the transmission 4 is not provided, and the electric motor 2 and the compressor 3 are directly connected to each other.

### Configuration of Electric Motor

The electric motor 2 is indirectly coupled to the compressor 3 via the transmission 4. The electric motor 2 is a so-called motor, and is a rotary machine that drives the compressor 3. The electric motor 2 includes a rotor 21, a casing 25, and a shaft bearing device 24.

The rotor 21 includes a rotor shaft 22. The rotor shaft 22 extends in an axial direction Da, in which a first axis C1 extends. The rotor shaft 22 has a cylindrical shape centered on the first axis C1. The rotor shaft 22 is rotatably supported by the shaft bearing device 24. A permanent magnet (not illustrated) is fixed to an outside surface of the rotor shaft 22. The rotor shaft 22 integrally includes an output shaft 23 at the other end thereof in the axial direction Da (the direction in which the first axis C1 extends). The output shaft 23 extends in the axial direction Da. The output shaft 23 has a cylindrical shape centered on the first axis C1.

The shaft bearing device 24 supports the rotor shaft 22 in a rotatable manner about the first axis C1. The shaft bearing device 24 includes a first shaft bearing device 24A and a second shaft bearing device 24B. The first shaft bearing device 24A is disposed at a position close to one end (first end) of the rotor shaft 22 in the axial direction Da. The second shaft bearing device 24B is disposed at a position close to the other end (second end) of the rotor shaft 22 in the axial direction Da. The first shaft bearing device 24A and the second shaft bearing device 24B each include a radial bearing.

The casing 25 covers the rotor 21 from the outer side in the radial direction centered on the first axis C1. The casing 25 includes a stator that covers the rotor shaft 22 and the permanent magnet from the outer side in the radial direction. The rotor shaft 22 is rotationally driven by an AC magnetic field generated by the stator.

### Configuration of Compressor

The compressor 3 is disposed side by side with the electric motor 2 in the axial direction Da with a space interposed therebetween. The compressor 3 compresses a working fluid taken in from the outside to generate a compressed fluid. Note that the type and usage of the compressed fluid generated by the compressor 3 are not limited in any way. The rotation of the output shaft 23 is transmitted to the compressor 3 of the present embodiment via the transmission 4. The compressor 3 of the present embodiment is, for example, a multi-stage centrifugal compressor. The compressor 3 includes a compressor rotor 33, at least one impeller (not illustrated), and a compressor shaft bearing device 32.

The compressor rotor 33 extends along a second axis C2. The compressor rotor 33 has a cylindrical shape centered on the second axis C2. The second axis C2 is parallel to the first axis C1 and extends in the axial direction Da. The first axis C1 and the second axis C2 are disposed at positions shifted from each other in a direction orthogonal to the axial direction Da. A plurality of the impellers (not illustrated) are disposed on the outside surface of the compressor rotor 33 at intervals in the axial direction Da.

The compressor shaft bearing device 32 supports the compressor rotor 33 in a rotatable manner about the second axis C2. The compressor shaft bearing device 32 includes a first compressor shaft bearing device 32A and a second compressor shaft bearing device 32B. The first compressor shaft bearing device 32A is disposed at a position close to one end (first end) of the compressor rotor 33 in the axial direction Da. The second compressor shaft bearing device 32B is disposed at a position close to the other end (second end) of the compressor rotor 33 in the axial direction Da. The first compressor shaft bearing device 32A includes a radial bearing. The second compressor shaft bearing device 32B includes a radial bearing and a thrust bearing.

### Configuration of Transmission

The transmission 4 increases or decreases the speed of rotation of the electric motor 2 by multiple gears 43 and 44, and transmits the rotation to the compressor 3. The transmission 4 is disposed between the electric motor 2 and the compressor 3 in the axial direction Da. The transmission 4 of the present embodiment includes a transmission input shaft 41 coupled to the output shaft 23, a transmission output shaft 42 coupled to the compressor rotor 33, input-side gear 43, and the output-side gear 44. The gears 43 and 44 are accommodated in a transmission casing 48. The input-side gear 43 and the output-side gear 44 are meshed with each other.

The transmission input shaft 41 extends along the first axis C1. The transmission input shaft 41 is rotated about the first axis C1 integrally with the output shaft 23. The input-side gear 43 is integrally fixed to the transmission input shaft 41. The transmission output shaft 42 extends along the second axis C2. The transmission output shaft 42 is rotated about the second axis C2 integrally with the compressor rotor 33. The transmission output shaft 42 extends parallel to the transmission input shaft 41 at a position shifted from the transmission input shaft 41 in a direction orthogonal to the axial direction Da. The output-side gear 44 is integrally fixed to the transmission output shaft 42.

The transmission 4 transmits the rotation of the transmission input shaft 41, which rotates integrally with the output shaft 23, to the transmission output shaft 42 via the two gears 43 and 44. As a result, the compressor rotor 33 rotates integrally with the transmission output shaft 42. In this way, the transmission 4 increases or decreases the speed of rotation of the output shaft 23, and transmits the rotation to the compressor rotor 33.

### Configuration of Oil Tank

An oil tank 6 stores lubricating oil M to be used in the electric motor 2, the transmission 4, and the compressor 3. The lubricating oil M of the present embodiment lubricates the shaft bearing device 24 (the first shaft bearing device 24A and the second shaft bearing device 24B), the compressor shaft bearing device 32 (the first compressor shaft bearing device 32A and the second compressor shaft bearing device 32B), and the gears and bearings (not illustrated) inside the transmission 4.

### Configuration of Lubricating Oil Supply Line

The lubricating oil supply line 7 is a pipe that supplies the lubricating oil M to the shaft bearing device 24, the compressor shaft bearing device 32, and the transmission 4. The lubricating oil supply line 7 includes a main supply line 70, a first supply line 71, a second supply line 72, and a third supply line 73.

One end of the main supply line 70 is connected to the oil tank 6. The first supply line 71, the second supply line 72, and the third supply line 73 are connected to the main supply line 70. A pump 75 is disposed in the main supply line 70. The pump 75 feeds the lubricating oil M in the oil tank 6 to the first supply line 71, the second supply line 72, and the third supply line 73.

The first supply line 71 supplies the lubricating oil M to the shaft bearing device 24. The first supply line 71 includes a first supply line 71A of one end side and a first supply line 71B of the other end side. The first supply line 71A of one end side connects the main supply line 70 and the first shaft bearing device 24A. The first supply line 71B of the other end side connects the main supply line 70 and the second shaft bearing device 24B. The lubricating oil M supplied through the first supply line 71 (the first supply line 71A of one end side and the first supply line 71B of the other end side) is used for lubrication in the shaft bearing device 24 (the first shaft bearing device 24A and the second shaft bearing device 24B).

The second supply line 72 supplies the lubricating oil M to the compressor shaft bearing device 32. The second supply line 72 includes a second supply line 72A of one end side and a second supply line 72B of the other end side. The second supply line 72A of one end side connects the main supply line 70 and the first compressor shaft bearing device 32A. The second supply line 72B of the other end side connects the main supply line 70 and the second compressor shaft bearing device 32B. The lubricating oil M supplied through the second supply line 72 (the second supply line 72A of one end side and the second supply line 72B of the other end side) is used for lubrication in the compressor shaft bearing device 32 (the first compressor shaft bearing device 32A and the second compressor shaft bearing device 32B).

The third supply line 73 supplies the lubricating oil M to the transmission 4. The third supply line 73 connects the main supply line 70 and the inside of the transmission casing 48 of the transmission 4. The lubricating oil M supplied through the third supply line 73 is used for lubrication of the gears 43 and 44 and the like in the transmission casing 48.

### Configuration of Drain Line

The drain line 8 feeds, to the oil tank 6, the lubricating oil M discharged from the shaft bearing device 24, the compressor shaft bearing device 32, and the transmission 4. The drain line 8 includes a first drain line 81, a second drain line 82, a third drain line 83, and a lower drain line 85.

The first drain line 81 discharges the lubricating oil M from the shaft bearing device 24. The first drain line 81 includes a first drain line 81A of one end side and a first drain line 81B of the other end side. A top end of the first drain line 81A of one end side is connected to the first shaft bearing device 24A. The first drain line 81A of one end side extends downward in a vertical direction Dv from the first shaft bearing device 24A. A top end of the first drain line 81B of the other end side is connected to the second shaft bearing device 24B. The first drain line 81B of the other end side extends downward in the vertical direction Dv from the second shaft bearing device 24B. The lubricating oil M used in the shaft bearing device 24 (the first shaft bearing device 24A and the second shaft bearing device 24B) and discharged therefrom is discharged down to the lower drain line 85 through the first drain line 81 (the first drain line 81A of one end side and the first drain line 81B of the other end side).

The second drain line 82 discharges the lubricating oil M from the compressor shaft bearing device 32. The second drain line 82 includes a second drain line 82A of one end side and a second drain line 82B of the other end side. A top end of the second drain line 82A of one end side is connected to the first compressor shaft bearing device 32A. The second drain line 82A of one end side extends downward in the vertical direction Dv from the first compressor shaft bearing device 32A. A top end of the second drain line 82B of the other end side is connected to the second compressor shaft bearing device 32B. The second drain line 82B of the other end side extends downward in the vertical direction Dv from the second compressor shaft bearing device 32B. The lubricating oil M used in the compressor shaft bearing device 32 (the first compressor shaft bearing device 32A and the second compressor shaft bearing device 32B) and discharged therefrom is discharged down to the lower drain line 85 through the second drain line 82 (the second drain line 82A of one end side and the second drain line 82B of the other end side).

The third drain line 83 discharges the lubricating oil M from the transmission 4. A top end of the third drain line 83 is connected to a lower portion of the transmission casing 48 of the transmission 4. The third drain line 83 extends downward in the vertical direction Dv from the lower portion of the transmission casing 48 of the transmission 4. The lubricating oil M used in the transmission 4 and discharged therefrom is discharged down to the lower drain line 85 through the third drain line 83.

### Configuration of Lower Drain Line

The lower drain line 85 is disposed below the first drain line 81, the second drain line 82, and the third drain line 83. The lower drain line 85 causes the lubricating oil M discharged from the first drain line 81, the second drain line 82, and the third drain line 83 to flow toward the oil tank 6. The lower drain line 85 extends from the first drain line 81 toward the oil tank 6. The lower drain line 85 is a pipe extending linearly from a base end portion 85a, which is one end in the axial direction Da, toward a tip portion 85b, which is the other end in the axial direction Da. The lower drain line 85 is inclined to descend obliquely downward from the base end portion 85a closest to the first drain line 81A of one end side toward the tip portion 85b closest to the oil tank 6, thereby having a predetermined drainage slope. The lower drain line 85 is inclined obliquely downward from the base end portion 85a toward the tip portion 85b at an inclination of approximately 1/25, for example.

The lower end of the first drain line 81 (the first drain line 81A of one end side, the first drain line 81B of the other end side), the lower end of the second drain line 82 (the second drain line 82A of one end side, the second drain line 82B of the other end side), and the lower end of the third drain line 83 are respectively connected to the lower drain line 85.

The oil tank 6 is connected to the tip portion 85b of the lower drain line 85. The oil tank 6 recovers the lubricating oil M recovered through the drain line 8.

In the rotary machine system 1A discussed above, the lubricating oil M discharged from the shaft bearing device 24, the compressor shaft bearing device 32, and the transmission 4 is discharged down to the lower drain line 85 through the first drain line 81, the second drain line 82, and the third drain line 83. The lubricating oil M discharged into the lower drain line 85 flows from the base end portion 85a as the upstream side toward the tip portion 85b as the downstream side due to the inclination of the lower drain line 85.

### Configuration of Negative Pressure Unit

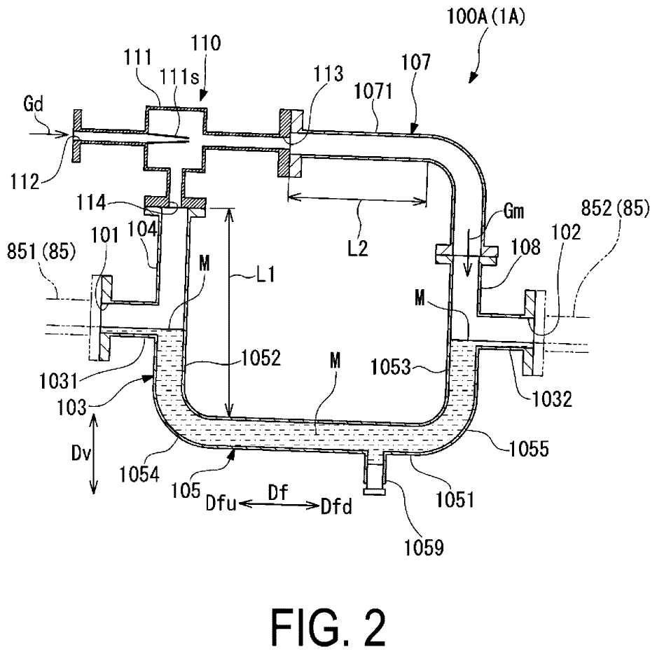

As illustrated in FIG. 2, the negative pressure unit 100A reduces pressure inside the shaft bearing device 24. The negative pressure unit 100A is disposed partway along the drain line 8. In the present embodiment, the negative pressure unit 100A is disposed partway along the lower drain line 85. The negative pressure unit 100A is disposed on a downstream side Dfd of the first drain line 81 in a flow direction Df of the lubricating oil M in the lower drain line 85. The negative pressure unit 100A is disposed at an upstream side Dfu in the flow direction Df in the lower drain line 85, relative to the second drain line 82 and the third drain line 83. That is, the negative pressure unit 100A is disposed in the lower drain line 85 between a position where the first drain line 81 and the lower drain line 85 are connected and positions where the second drain line 82 as well as the third drain line 83 and the lower drain line 85 are connected.

The lower drain line 85 includes an upstream-side lower drain line 851 located on the upstream side Dfu of the negative pressure unit 100A in the flow direction Df of the lubricating oil M. The upstream-side lower drain line 851 is connected to the first drain line 81. The lower drain line 85 further includes a downstream-side lower drain line 852 located on the downstream side Dfd of the negative pressure unit 100A in the flow direction Df of the lubricating oil M. The downstream-side lower drain line 852 is connected to the second drain line 82 and the third drain line 83.

Thus, the negative pressure unit 100A is disposed between the upstream-side lower drain line 851 and the downstream-side lower drain line 852 in the flow direction Df. The negative pressure unit 100A reduces the pressure at the upstream side Dfu in the flow direction Df relative to the position where the negative pressure unit 100A is disposed. That is, the negative pressure unit 100A of the present embodiment reduces the pressure inside the shaft bearing device 24, the upstream-side lower drain line 851, and the first drain line 81. In this way, the negative pressure unit 100A is not connected to any of the compressor shaft bearing device 32 and the transmission 4, but is substantially connected only to the shaft bearing device 24.

As illustrated in FIG. 2, the negative pressure unit 100A includes an oil inlet 101, an oil outlet 102, an oil flow pipe 103, an ejector 110, a suction pipe 104, and a gas discharge pipe 107.

The oil inlet 101 is connectable to the drain line 8. Specifically, the oil inlet 101 of the present embodiment is flange-connected to the upstream-side lower drain line 851. The oil inlet 101 communicates with the shaft bearing device 24 (the first shaft bearing device 24A and the second shaft bearing device 24B) via the lower drain line 85, the first drain line 81, and the second drain line 82.

The oil outlet 102 is connectable to the drain line 8. Specifically, the oil outlet 102 of the present embodiment is flange-connected to the downstream-side lower drain line 852. The oil outlet 102 communicates with the oil tank 6 via the lower drain line 85.

The oil flow pipe 103 connects the oil inlet 101 and the oil outlet 102. The oil flow pipe 103 forms a flow path for the lubricating oil M from the oil inlet 101 to the oil outlet 102. The oil flow pipe 103 of the present embodiment includes an inlet pipe section 1031, an oil retention pipe 105, and an outlet pipe section 1032.

The inlet pipe section 1031 extends from the oil inlet 101 toward the downstream side Dfd in the flow direction Df of the lubricating oil M in an extending direction of the upstream-side lower drain line 851. The outlet pipe section 1032 extends from the oil outlet 102 toward the upstream side Dfu in the flow direction Df of the lubricating oil M in an extending direction of the downstream-side lower drain line 852.

The oil retention pipe 105 is disposed between the oil inlet 101 and the oil outlet 102. The oil retention pipe 105 is connected to the inlet pipe section 1031 and the outlet pipe section 1032. The oil retention pipe 105 stores the lubricating oil M flowing into the inlet pipe section 1031 from the upstream-side lower drain line 851. The oil retention pipe 105 can store the lubricating oil M below the oil inlet 101 and the oil outlet 102 in the vertical direction Dv. The oil retention pipe 105 is located on the downstream side Dfd of a suction port 114 of the ejector 110 described later in the flow direction Df of the lubricating oil M. The oil retention pipe 105 of the present embodiment includes a bottom connection portion 1051, an upstream extension portion 1052, and a downstream extension portion 1053.

The bottom connection portion 1051 is located below the oil inlet 101 and the oil outlet 102 in the vertical direction Dv. The bottom connection portion 1051 is inclined downward in the vertical direction Dv from the upstream side Dfu toward the downstream side Dfd in the flow direction Df at an inclination of approximately 1/25, for example. The bottom connection portion 1051 is a region that entirely faces the lubricating oil M when the lubricating oil M is stored in the oil retention pipe 105. The bottom connection portion 1051 has a discharge port 1059 capable of being opened and closed to discharge the lubricating oil M at the time of maintenance or the like.

The upstream extension portion 1052 is connected to the bottom connection portion 1051 via a curved portion 1054 as a bent pipe at a position closer to the oil inlet 101 than the bottom connection portion 1051. The upstream extension portion 1052 extends upward in the vertical direction Dv with respect to the bottom connection portion 1051, while being inclined to the degree that does not obstruct the flow of the lubricating oil M. The upstream extension portion 1052 may extend straight upward in the vertical direction Dv from the bottom connection portion 1051. The upstream extension portion 1052 is a region at least partially facing the lubricating oil M when the lubricating oil M is stored in the oil retention pipe 105.

The downstream extension portion 1053 is connected to the bottom connection portion 1051 via a curved portion 1055 as a bent pipe at a position closer to the oil outlet 102 than the bottom connection portion 1051. The downstream extension portion 1053 extends upward in the vertical direction Dv with respect to the bottom connection portion 1051, while being inclined to the degree that does not obstruct the flow of the lubricating oil M. The downstream extension portion 1053 may extend straight upward in the vertical direction Dv from the bottom connection portion 1051. The downstream extension portion 1053 is a region at least partially facing the lubricating oil M when the lubricating oil M is stored in the oil retention pipe 105.

Further, the oil flow pipe 103 includes the suction pipe 104 and a connection pipe 108. A top end of the suction pipe 104 is flange-connected to the suction port 114 of the ejector 110 described later. The suction pipe 104 is located on the upstream side Dfu of the oil retention pipe 105 in the flow direction Df. The suction pipe 104 and the upstream extension portion 1052 are integrally formed such that the lower end of the suction pipe 104 is connected to the top end of the upstream extension portion 1052. The suction pipe 104 extends upward in the vertical direction Dv from a connection portion between the inlet pipe section 1031 and the upstream extension portion 1052, while being inclined to the degree that does not obstruct the flow of the lubricating oil M. The suction pipe 104 may extend straight upward in the vertical direction Dv.

The connection pipe 108 is located on the downstream side Dfd of the oil retention pipe 105 in the flow direction Df. The connection pipe 108 and the downstream extension portion 1053 are integrally formed such that the lower end of the connection pipe 108 is connected to the top end of the downstream extension portion 1053. The connection pipe 108 extends upward in the vertical direction Dv from a connection portion between the downstream extension portion 1053 and the outlet pipe section 1032, while being inclined to the degree that does not obstruct the flow of the lubricating oil M. The connection pipe 108 may extend straight upward in the vertical direction Dv.

The ejector 110 extracts gas in the oil flow pipe 103 to reduce the pressure in the oil flow pipe 103. The ejector 110 of the present embodiment includes an ejector main body 111, an external suction port 112, a discharge port 113, and the suction port 114. The ejector main body 111 forms therein a flow path for a drive gas Gd supplied from the outside. An ejector nozzle 111s is disposed in the ejector main body 111. The ejector nozzle 111s extends linearly in a direction connecting the external suction port 112 and the discharge port 113. The external suction port 112 sucks the drive gas Gd supplied from the outside into the ejector main body 111 (the ejector nozzle 111s). The discharge port 113 discharges the supplied drive gas Gd to the outside of the ejector main body 111. The suction port 114 communicates with a space in which the ejector nozzle 111s is disposed in the ejector main body 111. The suction port 114 is connected with the suction pipe 104. Thus, the suction port 114 is connected to the oil flow pipe 103. Here, the length from the suction port 114 to the bottom connection portion 1051 in the vertical direction Dv takes a length L1, which makes it possible to form an air flow in the suction pipe 104.

The drive gas Gd supplied from the outside flows through the ejector main body 111 from the external suction port 112 toward the discharge port 113. By the drive gas Gd passing through the ejector nozzle 111s in the ejector main body 111, the inside of the ejector main body 111 is set to a negative pressure (the pressure in the ejector main body 111 is lower than the pressure outside the ejector main body 111). Specifically, the inside of the ejector main body 111 is in a state close to a vacuum. As the pressure in the ejector main body 111 drops in this manner, gas in the suction pipe 104 is sucked into the ejector main body 111 through the suction port 114. With this, the ejector 110 extracts gas in the oil flow pipe 103 by utilizing the ejector effect to reduce the pressure in the oil flow pipe 103.

The gas discharge pipe 107 connects the discharge port 113 and the oil flow pipe 103. One end of the gas discharge pipe 107 is flange-connected to the discharge port 113. The other end of the gas discharge pipe 107 is flange-connected to the connection pipe 108. In this way, the other end of the gas discharge pipe 107 is connected to the oil flow pipe 103 between a position where the lubricating oil M is stored in the oil retention pipe 105 and the oil outlet 102 via the connection pipe 108. The gas discharge pipe 107 feeds a mixed gas Gm discharged from the discharge port 113 of the ejector main body 111 into the oil retention pipe 105 at the downstream side Dfd in the flow direction Df of the lubricating oil M relative to the bottom connection portion 1051. The mixed gas Gm is a gas in which the drive gas Gd in the ejector 110 and the gas sucked into the ejector main body 111 from the suction port 114 are mixed.

The gas discharge pipe 107 includes a first straight pipe section 1071. The first straight pipe section 1071 extends linearly from the discharge port 113 in a direction connecting the external suction port 112 and the discharge port 113 in the ejector 110. The first straight pipe section 1071 extends to have a predetermined length L2. The length L2 is set in such a manner as to suppress the pressure loss as much as possible with respect to the flow of the mixed gas Gm by not curving or bending the flow path for the mixed gas Gm discharged from the discharge port 113.

### Actions and Effects

In the rotary machine system 1A having the above-described configuration, the lubricating oil M discharged from the first shaft bearing device 24A is fed to the upstream-side lower drain line 851 through the first drain line 81A of one end side. Similarly, the lubricating oil M discharged from the second shaft bearing device 24B is fed to the upstream-side lower drain line 851 through the first drain line 81B of the other end side. In this way, the lubricating oil M discharged from the shaft bearing device 24 passes through the upstream-side lower drain line 851 and is fed to the oil inlet 101. The lubricating oil M fed to the oil inlet 101 flows into the inlet pipe section 1031. At this time, the lubricating oil M flows through a lower portion (a region below the center of the pipe) in the upstream-side lower drain line 851, the oil inlet 101, and the inlet pipe section 1031. That is, the lower portion in the upstream-side lower drain line 851, the oil inlet 101, and the inlet pipe section 1031 is a liquid form in which the lubricating oil M is present. On the other hand, an upper portion (a region above the center of the pipe) in the upstream-side lower drain line 851, the oil inlet 101, and the inlet pipe section 1031 is a gas form.

The negative pressure unit 100A includes the ejector 110 having the suction port 114 connected to the oil flow pipe 103. The ejector 110 flows the drive gas Gd in the ejector main body 111 from the external suction port 112 toward the discharge port 113. The drive gas Gd passes through the ejector nozzle 111s in the ejector main body 111, whereby the pressure in the ejector main body 111 is reduced to be in a state close to a vacuum. As the pressure in the ejector main body 111 drops, the gas filled in the oil flow pipe 103 is sucked into the ejector 110 through the suction port 114. As a result, the pressure in the oil flow pipe 103 drops. As the pressure in the oil flow pipe 103 drops, the pressure in the upstream-side lower drain line 851 connected to the oil flow pipe 103 drops. Accordingly, the pressure inside the first shaft bearing device 24A connected to the upstream-side lower drain line 851 via the first drain line 81A of one end side, and the pressure inside the second shaft bearing device 24B connected to the upstream-side lower drain line 851 via the first drain line 81B of the other end side also drop. This suppresses the leakage of the lubricating oil M from the first shaft bearing device 24A and the second shaft bearing device 24B.

The lubricating oil M flows into the oil retention pipe 105 from the inlet pipe section 1031. In the upstream extension portion 1052, the bottom connection portion 1051, and the downstream extension portion 1053 of the oil retention pipe 105, the lubricating oil M is stored at a portion below the oil inlet 101 and the oil outlet 102 in the vertical direction Dv. That is, in the oil retention pipe 105, the lubricating oil M is stored below the oil inlet 101 and the oil outlet 102 in the vertical direction Dv. The lubricating oil M stored in the oil retention pipe 105 is pushed out by the newly and sequentially supplied lubricating oil M, and then overflows from the top end of the downstream extension portion 1053 to the outlet pipe section 1032. The overflowing lubricating oil M flows from the outlet pipe section 1032 to the oil tank 6 through the downstream-side lower drain line 852.

In this manner, since the oil retention pipe 105 is filled with the stored lubricating oil M (particularly, the bottom connection portion 1051 is filled with the lubricating oil M), the oil flow pipe 103 is liquid-sealed between the oil inlet 101 and the oil outlet 102. With this, the inside of the oil flow pipe 103 is sealed between a region on the upstream side Dfu of the oil retention pipe 105 in the flow direction Df and a region on the downstream side Dfd of the oil retention pipe 105 in the flow direction Df by the lubricating oil M stored in the oil retention pipe 105. Therefore, the pressure drop generated by the ejector 110 has an effect on only the upstream-side lower drain line 851 via the suction pipe 104, and does not have an effect on the downstream-side lower drain line 852. In other words, in the oil flow pipe 103, the pressure drop brought by the ejector 110 does not spread to the region on the downstream side Dfd of the oil retention pipe 105 in the flow direction Df. Accordingly, the pressure inside the shaft bearing device 24 drops, whereas the pressure inside the compressor shaft bearing device 32 and the transmission 4 does not drop. In this manner, a situation in which the pressure drop brought by the ejector 110 spreads to portions other than the shaft bearing device 24 as a pressure reduction target may be suppressed while suppressing the leakage of the lubricating oil M from the shaft bearing device 24.

Further, by disposing the above-described negative pressure unit 100A partway along the drain line 8 and connecting it to the shaft bearing device 24 and the oil tank 6, it is possible to easily achieve the rotary machine system 1A including the above-described negative pressure unit 100A.

The oil retention pipe 105 includes the bottom connection portion 1051, the upstream extension portion 1052 extending upward in the vertical direction Dv with respect to the bottom connection portion 1051, and the downstream extension portion 1053 extending upward in the vertical direction Dv with respect to the bottom connection portion 1051. With this, the bottom connection portion 1051 is formed below the oil inlet 101 and the oil outlet 102 in the vertical direction Dv. Thus, the structure capable of storing the lubricating oil M may be easily formed with a simple configuration by the bottom connection portion 1051.

Further, the length from the suction port 114 to the bottom connection portion 1051 in the vertical direction Dv is defined as the length L1, which makes it possible to form an air flow in the suction pipe 104. With this, a situation in which the lubricating oil M, which is a liquid stored in the bottom connection portion 1051, is fed to the ejector 110 through the suction pipe 104 can be suppressed.

The gas discharge pipe 107 is connected to the discharge port 113 of the ejector 110 and to the oil flow pipe 103. The gas discharge pipe 107 is connected to the oil flow pipe 103 between a position where the lubricating oil M is stored in the oil retention pipe 105 and the oil outlet 102. Then, the mixed gas Gm in which the drive gas Gd in the ejector 110 and the gas sucked into the ejector main body 111 from the suction port 114 are mixed is discharged from the discharge port 113 to the gas discharge pipe 107. Because of this, the mixed gas Gm discharged from the discharge port 113 passes through the gas discharge pipe 107 and flows into the oil flow pipe 103 between the position where the lubricating oil M is stored in the oil retention pipe 105 and the oil outlet 102. The gas sucked into the ejector main body 111 from the suction port 114 contains mist-like lubricating oil M. Due to this, the mist-like lubricating oil M sucked from the suction port 114 may be mixed in the mixed gas Gm discharged from the discharge port 113. Even in such a case, the lubricating oil M mixed into the mixed gas Gm can be fed to the downstream-side lower drain line 852 and returned to the oil tank 6 without being discharged to the outside. Further, the flow of the lubricating oil M passing through the oil retention pipe 105 toward the oil tank 6 can be promoted by the mixed gas Gm flowing from the gas discharge pipe 107 into the oil flow pipe 103.

The gas discharge pipe 107 includes the first straight pipe section 1071 extending linearly from the discharge port 113 to have the predetermined length L2. As a result, in the region of the predetermined length L2 from the discharge port 113, there is no portion that causes pressure loss with respect to the flow of the mixed gas Gm discharged from the discharge port 113 of the ejectors 110. Thus, a situation in which a degradation in performance of the ejector 110 occurs may be suppressed. Accordingly, the gas in the oil flow pipe 103 can be stably sucked through the suction port 114, and the pressure inside the shaft bearing device 24 can be stably and continuously reduced.

In the rotary machine system 1A including the electric motor 2, the compressor 3, and the transmission 4, the negative pressure unit 100A is connected only to the shaft bearing device 24 of the electric motor 2. This makes it possible to reduce an internal pressure only in the shaft bearing device 24 having a larger clearance than the compressor shaft bearing device 32 and the transmission 4. Therefore, it is possible to suppress the leakage of the lubricating oil M by specifically focusing on the shaft bearing device 24 without affecting devices other than the shaft bearing device 24, such as the compressor shaft bearing device 32 and the transmission 4.

### Second Embodiment

Next, a second embodiment of a rotary machine system and a negative pressure unit according to the present disclosure will be described. Note that in the following description of the second embodiment, common components with the first embodiment described above are given the same reference signs in the drawings and explanations thereof are omitted. The second embodiment is different from the first embodiment in that a temperature sensor is provided.

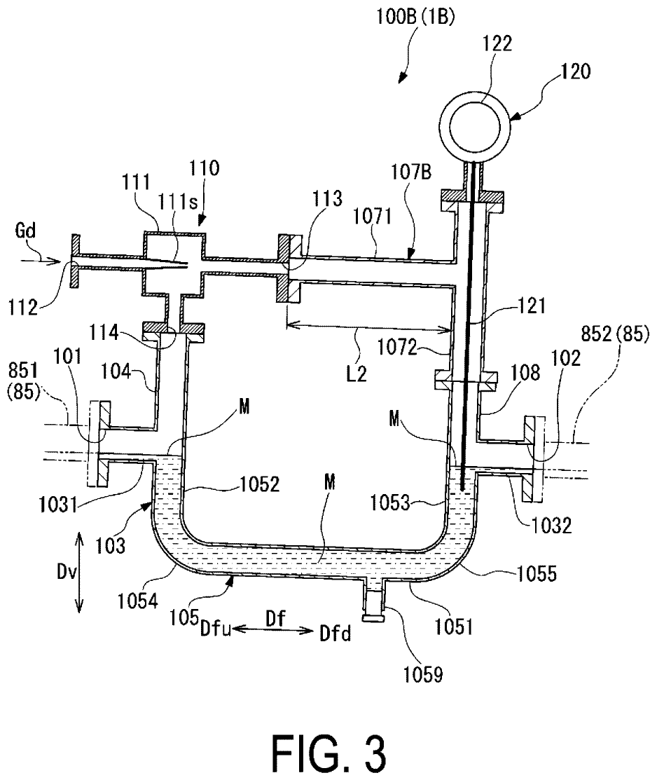

As illustrated in FIG. 3, in a rotary machine system 1B according to the second embodiment, a negative pressure unit 100B includes an oil inlet 101, an oil outlet 102, an oil flow pipe 103, an ejector 110, a suction pipe 104, a gas discharge pipe 107B, and a temperature sensor 120.

The gas discharge pipe 107B of the second embodiment includes a first straight pipe section 1071 and a second straight pipe section 1072. The second straight pipe section 1072 extends upward in the vertical direction Dv from a position where lubricating oil M is stored in an oil retention pipe 105 via a connection pipe 108. The second straight pipe section 1072 extends linearly upward in the vertical direction Dv with respect to a downstream extension portion 1053 in such a manner as to extend the connection pipe 108 in the vertical direction Dv. The lower end of the second straight pipe section 1072 is flange-connected to the connection pipe 108. A midway part of the second straight pipe section 1072 is connected to an end portion of the first straight pipe section 1071 at a position not connected to a discharge port 113 (a position away from the ejector 110).

The temperature sensor 120 includes a detecting unit 121 and a temperature visual recognition unit 122. The detecting unit 121 is configured to be able to detect the temperature of the lubricating oil M by a tip thereof coming into contact with the lubricating oil M. The detecting unit 121 extends linearly. The tip of the detecting unit 121 is located in a region of the downstream extension portion 1053, where the lubricating oil M is stored. That is, the detecting unit 121 extends to the lubricating oil M located in the downstream extension portion 1053 in a state of being inserted through the second straight pipe section 1072 and the connection pipe 108.

The temperature visual recognition unit 122 is connected to a base end of the detecting unit 121. A detection result of the detecting unit 121 can be visually recognized from the outside of the negative pressure unit 100B. The temperature visual recognition unit 122 is disposed outside the gas discharge pipe 107B. The temperature visual recognition unit 122 is supported by the second straight pipe section 1072. The temperature visual recognition unit 122 is connected to the top end of the second straight pipe section 1072.

### Actions and Effects

According to the rotary machine system 1B including the negative pressure unit 100B of the above-described configuration, in addition to the same operational effects as those of the first embodiment described above, the gas discharge pipe 107B includes the second straight pipe section 1072 extending upward in the vertical direction Dv from the position where the lubricating oil M is stored in the oil retention pipe 105. Then, the linearly extending detecting unit 121 is disposed in a state of passing through the second straight pipe section 1072. This makes it possible to easily dispose the temperature sensor 120 including the linearly extending detecting unit 121. Therefore, the temperature of the lubricating oil M accumulated in the oil retention pipe 105 can be detected with a simple configuration.

### Other Embodiments

Although the embodiments of the present disclosure have been described in detail with reference to the accompanying drawings, specific configurations are not limited to these embodiments, and design changes and the like without departing from the gist of the present disclosure are also included.

For example, in the first embodiment and the second embodiment, the oil retention pipe 105 is configured to include the bottom connection portion 1051, the upstream extension portion 1052, and the downstream extension portion 1053, but the present disclosure is not limited to such configuration.

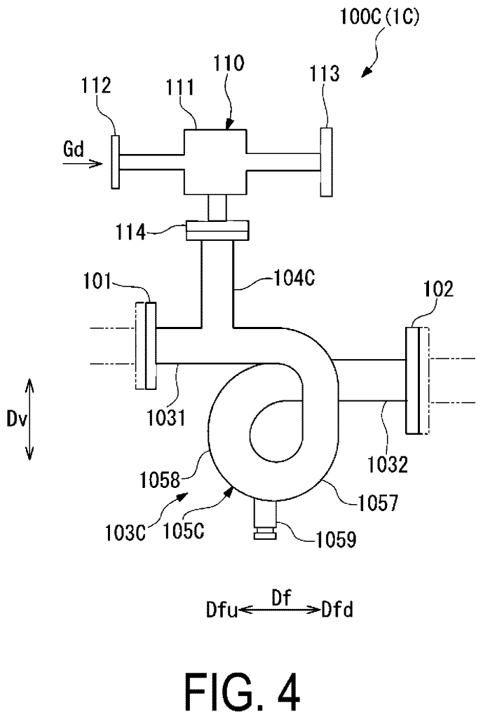

To be specific, as illustrated in FIG. 4, a negative pressure unit 100C of a rotary machine system 1C may include, as an oil retention pipe 105C, an upstream curved portion 1057 curved downward in the vertical direction Dv from an inlet pipe section 1031, and a downstream curved portion 1058 curved upward in the vertical direction Dv continuously from the upstream curved portion 1057 and connected to an outlet pipe section 1032. The above-mentioned oil retention pipe 105C is formed to loop in a spiral shape by the upstream curved portion 1057 and the downstream curved portion 1058. By looping the oil retention pipe 105C in this manner, the negative pressure unit 100C can be made to be compact in a direction connecting an oil inlet 101 and an oil outlet 102.

In each embodiment, the suction pipe 104 extends upward from the connection portion between the inlet pipe section 1031 and the upstream extension portion 1052, but the present disclosure is not limited to such configuration. For example, as illustrated in FIG. 4, a suction pipe 104C may extend upward from the midway part of the inlet pipe section 1031 as long as the suction pipe 104C is connected to an oil flow pipe 103C on the upstream side Dfu of the oil retention pipe 105C in the flow direction Df.

Further, in each embodiment, the gas discharge pipe 107 connecting the ejector 110 and the oil flow pipe 103 is provided, but the present disclosure is not limited to such configuration. As illustrated in FIG. 4, the gas discharge pipe 107 is not needed to be provided, and a mixed gas Gm discharged from a discharge port 113 of an ejector 110 may be discharged to a portion other than the oil flow pipe 103, such as the outside of the negative pressure unit 100C.

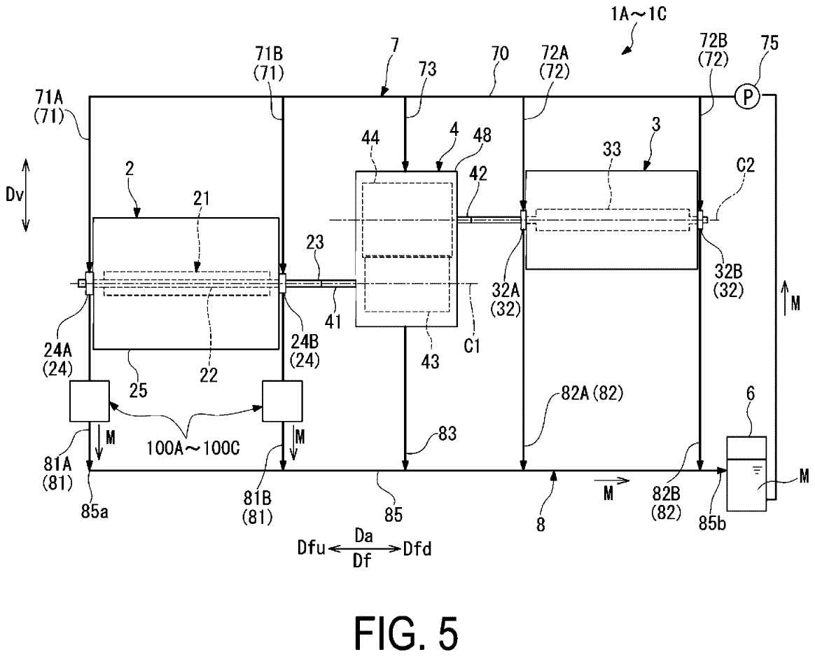

In the above embodiments, the negative pressure units 100A to 100C are each connected to the first drain line 81 at the downstream side Dfd thereof in the flow direction Df rather than connected to each first drain line 81 in the lower drain line 85 of the drain line 8, but the present disclosure is not limited to such structure. For example, as illustrated in FIG. 5, the negative pressure units 100A to 100C may be individually disposed to correspond to each shaft bearing device 24. That is, the negative pressure units 100A to 100C may each be connected partway along the first drain line 81 at the upstream side Dfu of the lower drain line 85 in the flow direction Df. In other words, the negative pressure units 100A to 100C may be separately disposed partway along a first drain line 81A of one end side and a first drain line 81B of the other end side.

In the above embodiments, the electric motor 2 is exemplified as the rotary machine, but the rotary machine may be, for example, a turbine. In this case, the rotary machine system may include a generator driven by the turbine instead of the compressor 3.

### Supplementary Notes

The rotary machine systems 1A to 1C and the negative pressure units 100A to 100C described in the embodiments are understood as follows, for example.
(1) The rotary machine systems 1A to 1C according to a first aspect includes: the rotary machine 2 including the rotor 21 having the rotor shaft 22 rotatable about the axis C1, the casing 25 covering the rotor 21 from an outer side in a radial direction centered on the axis C1, and the shaft bearing device 24 rotatably supporting the rotor shaft 22 with respect to the casing 25; the drain line 8 configured to recover the lubricating oil M supplied to the shaft bearing device 24; the oil tank 6 configured to store the lubricating oil M recovered through the drain line 8; and the negative pressure units 100A to 100C each disposed partway along the drain line 8 and each configured to reduce pressure inside the shaft bearing device 24. The negative pressure units 100A to 100C each include the oil inlet 101 connected to the drain line 8 and communicating with the shaft bearing device 24, the oil outlet 102 connected to the drain line 8 and communicating with the oil tank 6, the oil flow pipe 103 connecting the oil inlet 101 and the oil outlet 102 and forming a flow path for the lubricating oil M, and the ejector 110 including the suction port 114 connected to the oil flow pipe 103 and configured to extract gas in the oil flow pipe 103 through the suction port 114 to reduce pressure in the oil flow pipe 103. The oil flow pipe 103 includes the oil retention pipe 105, 105C located on the downstream side Dfd of the suction port 114 in the flow direction Df of the lubricating oil M and capable of storing the lubricating oil M below the oil inlet 101 and the oil outlet 102 in the vertical direction Dv.

With this, a fluid in the oil flow pipe 103 is sucked into the ejector 110 through the suction port 114. As a result, the pressure in the oil flow pipe 103 drops. As the pressure in the oil flow pipe 103 drops, the pressure in the drain line 8 connected to the oil flow pipe 103 drops. Accordingly, the pressure inside the shaft bearing device 24 also drops via the drain line 8. This suppresses the leakage of the lubricating oil M from the shaft bearing device 24. The lubricating oil M fed to the oil inlet 101 flows into the oil retention pipe 105. In the oil retention pipe 105, the lubricating oil M is stored at a portion below the oil inlet 101 and the oil outlet 102 in the vertical direction Dv. In this manner, since the oil retention pipe 105 is filled with the stored lubricating oil M, the oil flow pipe 103 is liquid-sealed between the oil inlet 101 and the oil outlet 102. Accordingly, in the oil flow pipe 103, the pressure drop brought by the ejector 110 does not spread to a region on the downstream side Dfd of the oil retention pipe 105 in the flow direction Df. Therefore, while the pressure inside the shaft bearing device 24 drops, the pressure in the region on the downstream side Dfd of the oil retention pipe 105 in the flow direction Df does not drop. In this manner, a situation in which the pressure drop brought by the ejector 110 spreads to portions other than the shaft bearing device 24 as a pressure reduction target may be suppressed while suppressing the leakage of the lubricating oil M from the shaft bearing device 24.
(2) The rotary machine systems 1A and 1B according to a second aspect are the rotary machine systems 1A and 1B according to (1), wherein the oil retention pipe 105 includes the bottom connection portion 1051 located below the oil inlet 101 and the oil outlet 102 in the vertical direction Dv, the upstream extension portion 1052 connected to the bottom connection portion 1051 at a position close to the oil inlet 101 and extending upward in the vertical direction Dv with respect to the bottom connection portion 1051, and the downstream extension portion 1053 connected to the bottom connection portion 1051 at a position close to the oil outlet 102 and extending upward in the vertical direction Dv with respect to the bottom connection portion 1051.

With this, the bottom connection portion 1051 is formed below the oil inlet 101 and the oil outlet 102 in the vertical direction Dv. Thus, the structure capable of storing the lubricating oil M may be easily formed with a simple configuration by the bottom connection portion 1051.
(3) The rotary machine systems 1A and 1B according to a third aspect are the rotary machine systems 1A and 1B according to (2), wherein the oil flow pipe 103 further includes the suction pipe 104 configured to connect the suction port 114 and the upstream extension portion 1052, and a length from the suction port 114 to the bottom connection portion 1051 in the vertical direction Dv takes a length L1, which makes it possible to form an air flow in the suction pipe 104.

With this, a situation in which the lubricating oil M, which is a liquid stored in the bottom connection portion 1051, is fed to the ejector 110 through the suction pipe 104 can be suppressed.
(4) The rotary machine systems 1A and 1B according to a fourth aspect are the rotary machine systems 1A and the 1B according to any one of (1) to (3), the rotary machine systems 1A and 1B each further including the gas discharge pipe 107 connected to the discharge port 113, from which the drive gas Gd supplied in the ejector 110 is discharged, and the oil flow pipe 103, wherein the gas discharge pipe 107 is connected to the oil flow pipe 103 between a position where the lubricating oil M is stored in the oil retention pipe 105 and the oil outlet 102.

Because of this, the gas discharged from the discharge port 113 passes through the gas discharge pipe 107 and flows into the oil flow pipe 103 between the position where the lubricating oil M is stored in the oil retention pipe 105 and the oil outlet 102. The gas sucked into the ejector 110 from the suction port 114 contains mist-like lubricating oil M. Due to this, the mist-like lubricating oil M sucked from the suction port 114 may be mixed in the gas discharged from the discharge port 113. Even in such a case, the lubricating oil M mixed into the gas can be returned to the oil tank 6 without being discharged to the outside.
(5) The rotary machine systems 1A and 1B according to a fifth aspect are the rotary machine systems 1A and the 1B according to (4), wherein the gas discharge pipe 107 includes the first straight pipe section 1071 linearly extending from the discharge port 113 by a predetermined length in a direction connecting the external suction port 112 configured to suck the drive gas Gd from the outside and the discharge port 113 in the ejector 110.

As a result, in the region of the predetermined length L2 from the discharge port 113, there is no portion that causes pressure loss with respect to the flow of the gas discharged from the discharge port 113 of the ejector 110. Thus, a situation in which a degradation in performance of the ejector 110 occurs may be suppressed. Accordingly, the gas in the oil flow pipe 103 can be stably sucked through the suction port 114, and the pressure inside the shaft bearing device 24 can be stably and continuously reduced.
(6) The rotary machine system 1B according to a sixth aspect is the rotary machine system 1B according to (4) or (5), the rotary machine system 1B further including the temperature sensor 120 capable of detecting, from the outside, the temperature of the lubricating oil M accumulated in the oil retention pipe 105, wherein the gas discharge pipe 107B includes the second straight pipe section 1072 extending upward in the vertical direction Dv from a position where the lubricating oil M is stored in the oil retention pipe 105; the temperature sensor 120 includes the detecting unit 121 extending linearly and being capable of detecting the temperature of the lubricating oil M by a tip thereof coming into contact with the lubricating oil M, and the temperature visual recognition unit 122 connected to a base end of the detecting unit 121 and disposed outside the gas discharge pipe 107B, and capable of visually recognizing a detection result of the detecting unit 121; and the detecting unit 121 is disposed in a state of passing through the second straight pipe section 1072.

This makes it possible to easily dispose the temperature sensor 120 including the linearly extending detecting unit 121. Therefore, the temperature of the lubricating oil M accumulated in the oil retention pipe 105 can be detected with a simple configuration.
(7) The rotary machine systems 1A to 1C according to a seventh aspect are the rotary machine systems 1A to 1C according to any one of (1) to (6), the rotary machine systems 1A to 1C each including the electric motor 2 serving as the rotary machine 2, the compressor 3 including the compressor rotor 33 configured to rotate together with the rotor 21 and also including the compressor shaft bearing device 32 configured to rotatably support the compressor rotor 33, and the transmission 4 disposed between the electric motor 2 and the compressor 3, wherein the negative pressure units 100A to 100C are each connected to only the shaft bearing device 24 of the electric motor 2.

This makes it possible to reduce an internal pressure only in the shaft bearing device 24 having a larger clearance than the compressor shaft bearing device 32 and the transmission 4. Therefore, it is possible to suppress the leakage of the lubricating oil M by specifically focusing on the shaft bearing device 24 without affecting devices other than the shaft bearing device 24, such as the compressor shaft bearing device 32 and the transmission 4.
(8) The negative pressure units 100A to 100C according to an eighth aspect are the negative pressure units 100A to 100C each disposed partway along the drain line 8 configured to feed, to the oil tank 6, the lubricating oil M supplied to the shaft bearing device 24 of the rotary machine 2, the negative pressure units 100A to 100C each including: oil inlet 101 connectable to the drain line 8 and communicating with the shaft bearing device 24; the oil outlet 102 connected to the drain line 8 and communicating with the oil tank 6; the oil flow pipe 103 connecting the oil inlet 101 and the oil outlet 102 and forming a flow path for the lubricating oil M; and the ejector 110 including the suction port 114 connected to the oil flow pipe 103 and configured to extract gas in the oil flow pipe 103 through the suction port 114 to reduce the pressure in the oil flow pipe 103. The oil flow pipe 103 includes the oil retention pipe 105, 105C located on the downstream side Dfd of the suction port 114 in the flow direction Df of the lubricating oil M and capable of storing the lubricating oil M below the oil inlet 101 and the oil outlet 102 in the vertical direction Dv.

By disposing the above-discussed negative pressure units 100A to 100C partway along the drain line 8, a situation in which the pressure drop brought by the ejector 110 spreads to portions other than the shaft bearing device 24 as a pressure reduction target may be suppressed while suppressing the leakage of the lubricating oil M from the shaft bearing device 24.

### INDUSTRIAL APPLICABILITY

According to the rotary machine systems and the negative pressure units of the present disclosure, a situation in which a pressure reduction brought by an ejector spreads to portions other than a shaft bearing device as a pressure reduction target may be suppressed while suppressing the leakage of lubricating oil from the shaft bearing device.

### REFERENCE SIGNS LIST

1A to 1C Rotary machine system
2 Electric motor (Rotary machine)
3 Compressor
4 Transmission
6 Oil tank
7 Lubricating oil supply line
8 Drain line
10 Sensor support pipe
21 Rotor
22 Rotor shaft
23 Output shaft
24 Shaft bearing device
24A First shaft bearing device
24B Second shaft bearing device
25 Casing
32 Compressor shaft bearing device
32A First compressor shaft bearing device
32B Second compressor shaft bearing device
33 Compressor rotor
41 Transmission input shaft
42 Transmission output shaft
43, 44 Gear
48 Transmission casing
70 Main supply line
71 First supply line
71A First supply line of one end side
71B First supply line of the other end side
72 Second supply line
72A Second supply line of one end side
72B Second supply line of the other end side
73 Third supply line
75 Pump
81 First drain line
81A First drain line of one end side
81B First drain line of the other end side
82 Second drain line
82A Second drain line of one end side
82B Second drain line of the other end side
83 Third drain line
85 Lower drain line
851 Upstream-side lower drain line
852 Downstream-side lower drain line
85a Base end portion
85b Tip portion
100A to 100C Negative pressure unit
101 Oil inlet
102 Oil outlet
103 Oil flow pipe
1031 Inlet pipe section
1032 Outlet pipe section
104, 104C Suction pipe
105, 105C Oil retention pipe
1051 Bottom connection portion
1052 Upstream extension portion
1053 Downstream extension portion
1054 Curved portion
1055 Curved portion
1057 Upstream curved portion
1058 Downstream curved portion
1059 Discharge port
107, 107B Gas discharge pipe
1071 First straight pipe section
1072 Second straight pipe section
108 Connection pipe
110 Ejector
111 Ejector main body
111s Ejector nozzle
112 External suction port
113 Discharge port
114 Suction port
120 Temperature sensor
121 Detecting unit
122 Temperature visual recognition unit
C1 First axis (Axis)
C2 Second axis
Da Axial direction
Df Flow direction
Dfd Downstream side
Dfu Upstream side
Dv Vertical direction
Gd Drive gas
Gm Mixed gas
M Lubricating oil

1. A rotary machine system comprising:
a rotary machine including a rotor having a rotor shaft rotatable about an axis, a casing covering the rotor from an outer side in a radial direction centered on the axis, and a shaft bearing device rotatably supporting the rotor shaft with respect to the casing;
a drain line that recovers lubricating oil supplied to the shaft bearing device;
an oil tank that stores the lubricating oil recovered through the drain line; and
a negative pressure unit that is disposed partway along the drain line and reduces pressure inside the shaft bearing device, wherein
the negative pressure unit includes
an oil inlet connected to the drain line and communicating with the shaft bearing device,
an oil outlet connected to the drain line and communicating with the oil tank,
an oil flow pipe that connects the oil inlet and the oil outlet and forms a flow path for the lubricating oil, and
an ejector that includes a suction port connected to the oil flow pipe and extracts gas in the oil flow pipe through the suction port to reduce pressure in the oil flow pipe,
the oil flow pipe includes an oil retention pipe that is located on a downstream side of the suction port in a flow direction of the lubricating oil and is capable of storing the lubricating oil below the oil inlet and the oil outlet in a vertical direction,
the rotary machine system further comprises a gas discharge pipe connected to a discharge port from which a drive gas supplied in the ejector is discharged, and the oil flow pipe, and
the gas discharge pipe is connected to the oil flow pipe between a position where the lubricating oil is stored in the oil retention pipe and the oil outlet.

2. The rotary machine system according to claim 1, wherein the oil retention pipe includes
a bottom connection portion located below the oil inlet and the oil outlet in the vertical direction,
an upstream extension portion connected to the bottom connection portion at a position close to the oil inlet and extending upward in the vertical direction with respect to the bottom connection portion, and
a downstream extension portion connected to the bottom connection portion at a position close to the oil outlet and extending upward in the vertical direction with respect to the bottom connection portion.

3. The rotary machine system according to claim 2, wherein
the oil flow pipe further includes a suction pipe connecting the suction port and the upstream extension portion, and
a length from the suction port to the bottom connection portion in the vertical direction takes a length that makes it possible to form an air flow in the suction pipe.

4. (canceled)

5. The rotary machine system according to claim 1, wherein the gas discharge pipe includes a first straight pipe section linearly extending from the discharge port by a predetermined length in a direction connecting an external suction port that sucks the drive gas from an outside and the discharge port in the ejector.

6. The rotary machine system according to claim 1, further comprising:
a temperature sensor capable of detecting, from an outside, a temperature of the lubricating oil accumulated in the oil retention pipe, wherein
the gas discharge pipe includes a second straight pipe section extending upward in the vertical direction from a position where the lubricating oil is stored in the oil retention pipe,
the temperature sensor includes
a detecting unit extending linearly and being capable of detecting the temperature of the lubricating oil by a tip of the detecting unit coming into contact with the lubricating oil, and
a temperature visual recognition unit connected to a base end of the detecting unit and disposed outside the gas discharge pipe, and capable of visually recognizing a detection result of the detecting unit, and
the detecting unit is disposed in a state of passing through the second straight pipe section.

7. The rotary machine system according to claim 1, further comprising:
an electric motor serving as the rotary machine;
a compressor including a compressor rotor that rotates together with the rotor and also including a compressor shaft bearing device that rotatably supports the compressor rotor; and
a transmission disposed between the electric motor and the compressor, wherein
the negative pressure unit is connected to only the shaft bearing device of the electric motor.

8. A negative pressure unit that is disposed partway along a drain line configured to feed, to an oil tank, lubricating oil supplied to a shaft bearing device of a rotary machine, the negative pressure unit comprising:
an oil inlet connectable to the drain line and communicating with the shaft bearing device;
an oil outlet connectable to the drain line and communicating with the oil tank;
an oil flow pipe that connects the oil inlet and the oil outlet and forms a flow path for the lubricating oil; and
an ejector that includes a suction port connected to the oil flow pipe and extracts gas in the oil flow pipe through the suction port to reduce pressure in the oil flow pipe, wherein
the oil flow pipe includes an oil retention pipe that is located on a downstream side of the suction port in a flow direction of the lubricating oil and is capable of storing the lubricating oil below the oil inlet and the oil outlet in a vertical direction.
